(19) United States
(12) Patent Application Publication
(10) Pub. No.: US 2012/0033148 A1
(43) Pub. Date: Feb. 9, 2012

(54) LIQUID CRYSTAL DISPLAY

(75) Inventors: Byung-Duk YANG, Yongin-si (KR); Young-Hoon YOO, Asan-si (KR); Dong-Yoon KIM, Seoul (KR); Hyang-Shik KONG, Seongnam-si (KR); Jang-Soo KIM, Yongin-si (KR)

(73) Assignee: SAMSUNG ELECTRONICS CO., LTD., Suwon-si (KR)

(21) Appl. No.: 13/198,810

(22) Filed: Aug. 5, 2011

(30) Foreign Application Priority Data
Aug. 6, 2010 (KR) 10-2010-0075898

(51) Int. Cl. G02F 1/1343

(52) U.S. Cl. 349/39; 349/38

(57) ABSTRACT

A liquid crystal display includes first and second gate lines, a data line crossing the first and second gate lines, a pixel electrode including first and second sub-pixel electrodes electrically disconnected from each other, a first thin film transistor connected to the first gate line, the data line, and the first sub-pixel electrode, a second thin film transistor connected to the first gate line, the data line, and the second sub-pixel electrode, and a third thin film transistor connected to the second gate line, the second sub-pixel electrode, and a charge sharing capacitor including a first and second electrode. A data voltage applied to the second sub-pixel electrode and to a first electrode swings between a negative voltage and a positive voltage with respect to a common voltage, and a voltage smaller than an average value of the negative voltage and the positive voltage is applied to a second electrode.

This application claims priority Korean Patent Application No. 10-2010-0075898, filed on Aug. 6, 2010, and all the benefits accruing therefrom under 35 U.S.C. §119, the disclosure of which is incorporated herein by reference in its entirety.

### BACKGROUND OF THE INVENTION

1. Field of the Invention

The invention relates to a liquid crystal display, and more particularly, to a liquid crystal display having a structure capable of improving lateral visibility.

2. Description of the Related Art

A liquid crystal display, which is a widely used type of flat panel display, includes two panels on which field generating electrodes, such as pixel electrodes, common electrodes, or the like, are disposed, and a liquid crystal layer interposed between the panels. A voltage is applied to the field generating electrodes to generate an electric field in the liquid crystal layer. The alignment of liquid crystal molecules in the liquid crystal layer is determined by the electric field and a polarization of incident light is controlled, thereby displaying an image.

A vertically aligned (“VA”) mode liquid crystal display, which has the long axes of liquid crystal molecules aligned perpendicular to upper and lower panels in a state that no voltage is applied to electrodes, is attaining much attention due to a high contrast ratio and an easily achievable wide reference viewing angle. Here, the reference viewing angle denotes a viewing angle corresponding to a contrast ratio of 1:10, or a brightness inversion limit angle between grayscales.

To widen the viewing angle in the VA mode liquid crystal display, cutouts may be formed in the electric field-generating electrodes. Also, protrusions may be formed on the electric field-generating electrodes to widen the reference viewing angle. Since the cutouts and the protrusions can be used to control the tilt directions of liquid crystal molecules, the liquid crystal molecules can be tilted in the desired directions by using the cutouts and the protrusions. In such a manner, the wide viewing angle can be secured.

Although the VA mode liquid crystal display provides a wide viewing angle, there is a problem in that its lateral visibility is inferior in comparison to its visibility from the front. For example, in a patterned VA (“PVA”) mode liquid crystal display provided with cutouts, images in the side portions of the liquid crystal display become brighter. In more severe cases, the brightness difference between high grayscales disappears, causing a distortion of the image.

Accordingly, a liquid crystal display having a structure capable of improving lateral visibility is desired.

### BRIEF SUMMARY OF THE INVENTION

The invention provides a liquid crystal display capable of reducing a residual image level while improving lateral visibility.

The above and other features of the invention will be described in or be apparent from the following description of exemplary embodiments.

In an exemplary embodiment of the invention, there is provided a liquid crystal display including first and second gate lines arranged in parallel in a first direction, a data line crossing the first and second gate lines while being insulated therefrom, a pixel electrode in a pixel region and including first and second sub-pixel electrodes electrically disconnected from each other, a first thin film transistor connected to the first gate line, the data line, and the first sub-pixel electrode, a second thin film transistor connected to the first gate line, the data line, and the second sub-pixel electrode, and a third thin film transistor connected to the second gate line, the second sub-pixel electrode, and a charge sharing capacitor. A data voltage applied to the second sub-pixel electrode swings between a negative voltage and a positive voltage with respect to a common voltage. The charge sharing capacitor includes a first electrode to which the data voltage is applied, and a second electrode to which a voltage that is a predetermined extent smaller than an average value of the negative voltage and the positive voltage is applied.

In another exemplary embodiment of the invention, there is provided a liquid crystal display including first and second gate lines arranged in parallel in a first direction, a storage wire disposed on a same layer with the first and second gate lines, a data line crossing the first and second gate lines while being insulated therefrom, a pixel electrode in a pixel region and including first and second sub-pixel electrodes electrically disconnected from each other, a first thin film transistor connected to the first gate line, the data line, and the first sub-pixel electrode, a second thin film transistor connected to the first gate line, the data line, and the second sub-pixel electrode, and a third thin film transistor connected to the second gate line, the second sub-pixel electrode, and a charge sharing capacitor. The charge sharing capacitor includes a first electrode as a drain electrode of the third thin film transistor, and a second electrode as the storage wire. A semiconductor layer is interposed between the first electrode and the second electrode.

### BRIEF DESCRIPTION OF THE DRAWINGS

The above and other features and advantages of the invention will become more apparent by describing in detail embodiments thereof with reference to the attached drawings in which:

FIG. 1 is a block diagram of an exemplary embodiment of a liquid crystal display, according to the invention;

FIG. 2 is a circuit diagram showing an exemplary embodiment of a unit pixel (“PX”) of the liquid crystal display shown in FIG. 1;

FIG. 3 is a plan view of an exemplary embodiment of a liquid crystal display, according to the invention;

FIG. 4 is a cross-sectional view taken along lines A-A′ and B-B′ of FIG. 3:

FIGS. 5 through 10 illustrate exemplary embodiments of intermediate processing steps of a manufacturing method of the liquid crystal display shown in FIGS. 3 and 4;

FIG. 11 is a plan view of an exemplary embodiment of a pixel electrode shown in FIG. 3;

FIGS. 12 and 13 illustrate problems presented in cases where a common voltage and a storage voltage are same;

FIGS. 14A through 14C illustrate capacitance-voltage (“C-V”) characteristics of a charge sharing capacitor depending on the storage voltage; and

FIG. 15 illustrates residual image levels of a liquid crystal display depending on the storage voltage.

### DETAILED DESCRIPTION OF THE INVENTION

Advantages and features of the invention and methods of accomplishing the same may be understood more readily by reference to the following detailed description of exemplary embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. In the drawings, the thickness of layers and regions are exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “above,” “upper,” “under” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments described herein will be described referring to plan views and/or cross-sectional views by way of ideal schematic views of the invention. Accordingly, the exemplary views may be modified depending on manufacturing technologies and/or tolerances. Therefore, the embodiments of the invention are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in further detail with reference to the accompanying drawings.

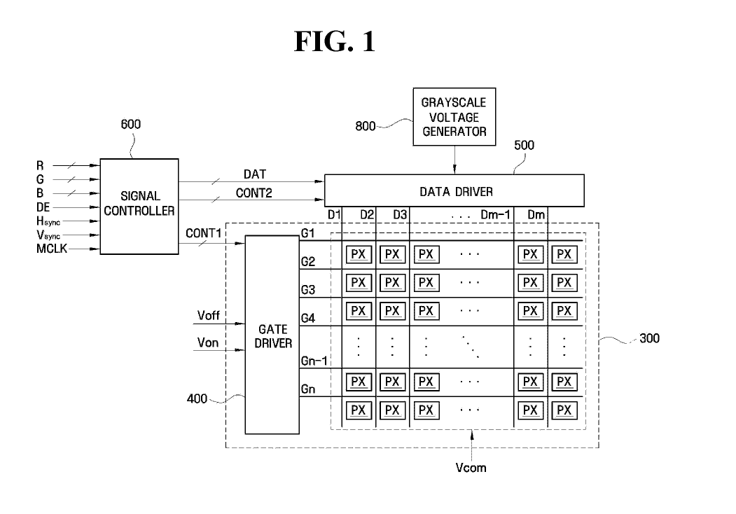

FIG. 1 is a block diagram of an exemplary embodiment of a liquid crystal display, according to the invention.

Referring to FIG. 1, the liquid crystal display includes a liquid crystal panel assembly 300, a gate driver 400 and a data driver 500 connected to the liquid crystal panel assembly 300, a grayscale voltage generator 800 connected to the data driver 500, and a signal controller 600 controlling these circuits.

In an equivalent circuit view, the liquid crystal panel assembly 300 includes a plurality of display signal lines, and a plurality of pixels PX connected to the display signal lines and arranged in substantially a matrix. Here, the liquid crystal panel assembly 300 includes a lower panel and an upper panel facing each other, and a liquid crystal layer interposed therebetween.

The display signal lines are provided in the lower panel, and include a plurality of gate lines GL1-GLn transmitting gate signals, and a plurality of data lines DL1-DLm transmitting data signals. The gate lines GL1-GLn longitudinally extend substantially in a column direction and are substantially parallel with each other. The data lines DL1-DLm longitudinally extend substantially in a row direction and are substantially parallel with each other.

Each of the pixels PX includes a switching element connected to a corresponding one of the gate lines GL1-GLn and a corresponding one of the data lines DL1-DLm, and a liquid crystal capacitor connected to the switching element. Here, a storage capacitor may be connected to the switching element of a pixel in parallel with a liquid crystal capacitor when necessary.

The switching element of each pixel PX includes a thin film transistor and is a three-port device having a control port connected to the corresponding one of the gate lines GL1-GLn, an input port connected to the corresponding one of the data lines DL1-DLm, and an output port connected to the liquid crystal capacitor.

The gate driver 400 is connected to the gate lines GL1-GLn and applies gate signals including a combination of a gate-on voltage Von in a high level and a gate-off voltage Voff in a low level, to the gate lines GL1-GLn.

The grayscale voltage generator 800 generates grayscale voltages corresponding to transmittance of pixels. The grayscale voltages are independently applied to each pixel PX. Each grayscale voltages include a positive value with respect to a common voltage Vcom and a negative value with respect to the common voltage Vcom.

The data driver 500 is connected to the data lines DL1-DLm of the liquid crystal panel assembly 300 and applies grayscale voltages from the grayscale voltage generator 800 to pixels PX as data voltages. Here, in a case where the grayscale voltage generator 800 generates only reference grayscale voltages instead of all the grayscale voltages, the data driver 500 generates the grayscale voltages by dividing the reference grayscale voltages and selects the data voltage among the generated grayscale voltages.

The gate driver 400 or the data driver 500 may be directly mounted in a form of a plurality of driving integrated circuit (“IC”) chips on the liquid crystal display panel assembly 300 together with the display signal lines (GL1-GLn, DL1-DLm), thin film transistors, and so on. Alternatively, the gate driver 400 or the data driver 500 may be attached in a form of a tape carrier package (“TCP”) on a flexible printed circuit (“FPC”) film (not shown), in the liquid crystal display panel assembly 300.

The signal controller 600 controls operations of the gate driver 400, the data driver 500, and the like.

The signal controller 600 receives input image signals R, G, and B, and input control signals for controlling the display from an external graphics controller (not shown). As an example of the input control signals, a vertical synchronization signal Vsync, a horizontal synchronization signal Hsync, a main clock signal MCLK, and a data enable signal DE are received. The signal controller 600 processes the image signals R, G, and B according to an operating condition of the liquid display panel assembly 300 based on the input control signals and the input image signals R, G, and B, to generate a gate control signal CONT1 and a data control signal CONT2. Thereafter, the signal controller 600 transmits the generated gate control signal CONT1 to the gate driver 400, and the generated data control signal CONT2 and a processed image signal DAT to the data driver 500.

The gate control signal CONT 1 includes a scanning start signal STV for indicating scanning starting, and at least one clock signal for controlling an output time of the gate-on voltage Von. The gate control signal CONT1 may also include an output enable signal OE for defining a duration time of the gate-on voltage Von. Here, the clock signal may be used as a selection signal SE.

The data control signal CONT2 includes a horizontal synchronization start signal STH for indicating data transmission for a group of pixels PX, a load signal LOAD for commanding to apply data voltages to the data lines DL1-DLm, and a data clock signal HCLK. The data control signal CONT2 may include a reverse signal RVS for inverting a polarity of the data voltage with respect to the common voltage Vcom (hereinafter, “the polarity of the data voltage with respect to the common voltage Vcom” being abbreviated to a “data voltage polarity”).

In response to the data control signal CONT2 from the signal controller 600, the data driver 500 receives the image data DAT for a group of the pixels PX, and selects a gray voltage corresponding to the image data DAT, so that the image data DAT is converted into the associated data voltage. Then, the data voltage is applied to the associated data lines DL1-DLm.

The gate driver 400 applies the gate-on voltage Von to the gate lines GL1-GLn to turn on the switching elements connected to the gate lines GL1-GLn in response to the gate control signal CONT1. As a result, the data voltages applied to the data lines DL1-DLm are applied to the associated pixels PX through the turned-on switching element.

The difference between the data voltage applied to each of the pixels PX and the common voltage Vcom becomes a charged voltage of the liquid crystal capacitors, that is, a pixel voltage. Alignment of the liquid crystal molecules varies according to the intensity of the pixel voltage. Polarization of light passing through the liquid crystal layer changes according to the alignment of the liquid crystal molecules. The change in the polarization results in a change in transmittance of the light.

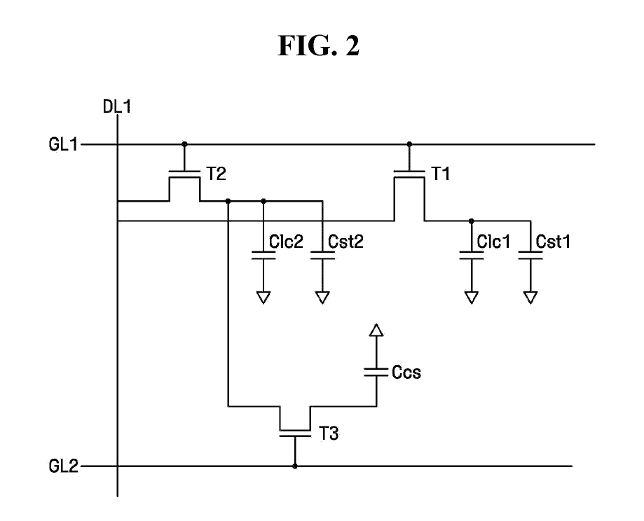

In the liquid crystal display according to the illustrated exemplary embodiment of the invention, when the gate-on voltage Von is applied to adjacent gate lines after the same data voltage is applied to a pair of sub-pixels constituting one pixel PX, the data voltage charged to one of the pair of sub-pixels is dropped in a charge sharing manner. In this way, different data voltages are charged to the pair of sub-pixels, so that the gamma curve of the one PX is a composite curve of the gamma curves of the pair of sub-pixels. In determining the data voltages charged to the respective sub-pixels, the composite gamma curve for the front view is determined to be close to a reference gamma curve for the front view, and the composite gamma curve for the lateral view is determined to be close to a reference gamma curve for the front view, thereby improving lateral visibility, which will below be described in greater detail with reference to FIG. 2.

FIG. 2 is a circuit diagram showing the liquid crystal display shown in FIG. 1, specifically an equivalent circuit diagram of an exemplary embodiment of a unit pixel (“PX”) of FIG. 1. A unit pixel may be defined as an independent area capable of independently controlling liquid crystal.

Referring to FIG. 2, the unit pixel PX of the liquid crystal display is connected to two adjacent gate lines, that is, first and second gate lines GL1 and GL2, and a data line DL1 crossing the first and second gate lines GL1 and GL2.

A first thin film transistor T1 and a second thin film transistor T2 are at an interconnection of the first gate line GL1 and the data line DL1, and a third thin film transistor T3 is connected to the second gate line GL2.

That is to say, the first thin film transistor T1 includes a gate electrode connected to the first gate line GL1, a source electrode connected to the data line DL1, and a drain electrode connected to a first liquid crystal capacitor Clc1 and a first storage capacitor Cst1. The second thin film transistor T2 includes a gate electrode connected to the first gate line GL1, a source electrode connected to the data line DL1, and a drain electrode connected to a second liquid crystal capacitor Clc2 and a second storage capacitor Cst2. The third thin film transistor T3 includes a gate electrode connected to the second gate line GL2, a source electrode connected to the drain electrode of the second thin film transistor T2, and a drain electrode connected to a charge sharing capacitor Ccs.

Each of the unit pixels PX on the lower panel with the aforementioned configuration includes a pixel electrode. The pixel electrode includes a first sub-pixel electrode connected to the drain electrode of the first thin film transistor T1, and a second sub-pixel electrode connected to the drain electrode of the second thin film transistor T2. A common electrode is on the upper panel facing the lower panel.

The first liquid crystal capacitor Clc1 includes the first sub-pixel electrode connected to the first thin film transistor T1, the common electrode, and liquid crystal material interposed therebetween. The first storage capacitor Cst1 includes the first sub-pixel electrode, storage lines on the lower panel, and dielectric material interposed therebetween.

The second liquid crystal capacitor Clc2 includes the second sub-pixel electrode connected to the second thin film transistor T2, the common electrode, and liquid crystal material interposed therebetween. The second storage capacitor Cst2 includes the second sub-pixel electrode, storage lines on the lower panel, and dielectric material interposed therebetween.

The charge sharing capacitor Ccs includes the drain electrode of the third thin film transistor T3, storage lines on the lower panel, and dielectric material interposed therebetween. Here, the charge sharing capacitor Ccs serves to reduce the data voltage stored in the second sub-pixel electrode connected to the second thin film transistor T2.

The liquid crystal display having the aforementioned configuration has improved lateral visibility in the following manner.

First, when an ON signal is transmitted to the first gate line GL1, the same data voltage is applied to the first and second sub-pixel electrodes positioned in a first row through the first thin film transistor T1 and the second thin film transistor T2. That is to say, the same data voltage is charged at one end of the first liquid crystal capacitor Clc1, and at one end of the second liquid crystal capacitor Clc2 connected to the first gate line GL1.

Subsequently, when an OFF signal is transmitted to the first gate line GL1, the first sub-pixel electrode and the second sub-pixel electrode are separated from each other. That is to say, when the same data voltage is applied to the first sub-pixel electrode and the second sub-pixel electrode, the first sub-pixel electrode and the second sub-pixel electrode are kept at a floating state.

Next, when an ON signal is transmitted to the second gate line GL2, the data voltage stored in the second sub-pixel electrode connected to the second thin film transistor T2 is shared with the charge sharing capacitor Ccs through the third thin film transistor T3. This is because the source electrode of the third thin film transistor T3 is connected to the second sub-pixel electrode connected to the second thin film transistor T2, and the drain electrode of the third thin film transistor T3 is connected to the charge sharing capacitor Ccs. Thus, the data voltages stored in the first and second sub-pixel electrodes positioned in the first row and connected to the first thin film transistor T1 and the second thin film transistor T2, respectively, are different from each other. More specifically, since the data voltage of the second sub-pixel electrode connected to the second thin film transistor T2 is shared with the charge sharing capacitor Ccs through the third thin film transistor T3, the data voltage of the second sub-pixel electrode is dropped.

When the data voltages stored in the first and second sub-pixel electrodes positioned in the same unit pixel PX are different from each other in the above-described manner, lateral visibility can be improved. That is to say, a pair of gray voltage sets having different gamma curves, originated from information on a single image, are stored in the first and second sub-pixel electrodes, so that the gamma curve of one unit pixel PX including first and second sub-pixels is a composite curve of the gamma curves of the first and second sub-pixels. In the determination of the two gray voltage sets, the composite gamma curve for the front view is determined to be close to a reference gamma curve for the front view, and the composite gamma curve for the lateral view is determined to be close to a reference gamma curve for the front view. In such a manner, it is possible to improve lateral visibility.

When an ON signal is applied to the second gate line GL2, as described above, the third thin film transistor T3 is turned on, a same data voltage may also be applied to a pair of sub-pixel electrodes positioned in a second row different from the first row, through a pair of thin film transistors (not shown) connected to the second gate line GL2, based on the above description. Next, when an OFF signal is applied to the second gate line GL2, a pair of sub-pixel electrodes connected to the second gate line GL2 are separated from each other and are kept at a floating state, based on the above description.

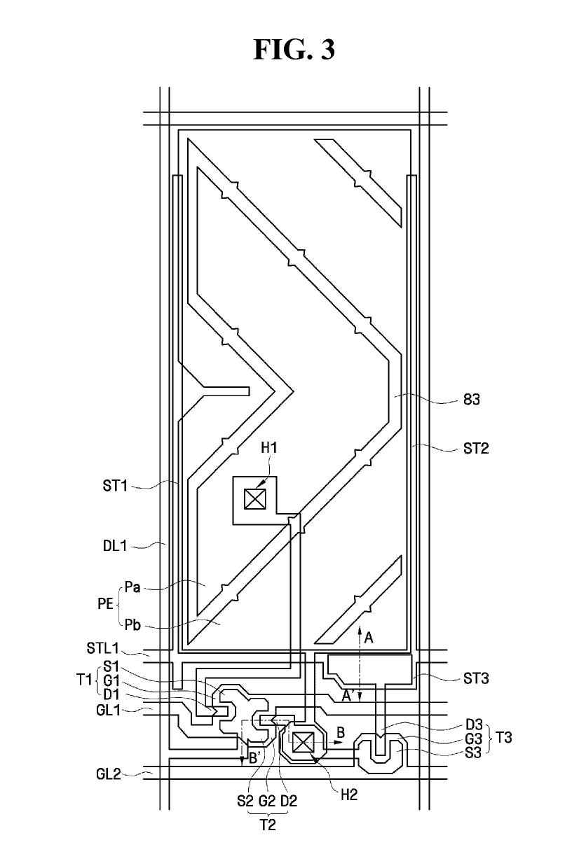

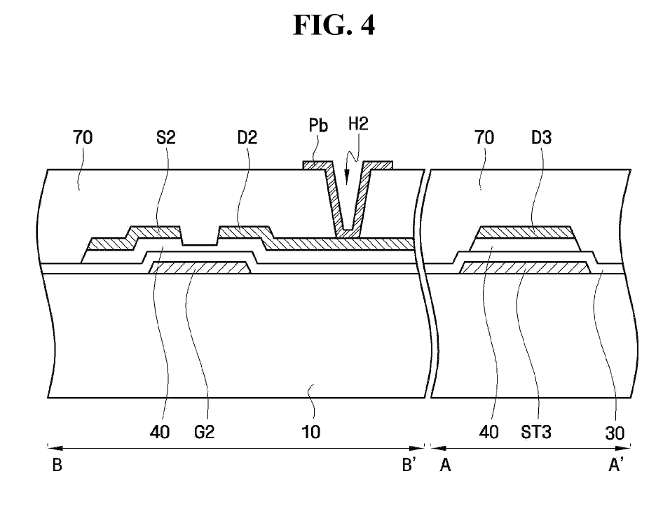

Hereinafter, a liquid crystal display having the unit pixel PX of FIG. 2 will further be described with reference to FIGS. 3 and 4. FIG. 3 is a plan view of an exemplary embodiment of a liquid crystal display according to the invention, and FIG. 4 is a cross-sectional view taken along lines A-A′ and B-B′ of FIG. 3. Specifically, FIG. 3 is a plan view of a portion of a unit pixel PX in a lower panel having thin film transistors, a plurality of display signal lines, and pixel electrodes.

As described above, the liquid crystal display according to the invention includes a lower panel, an upper panel having a common electrode, and a liquid crystal layer interposed between the upper and lower panels. In the following description, for brevity, the invention will be described with regard to only a lower panel.

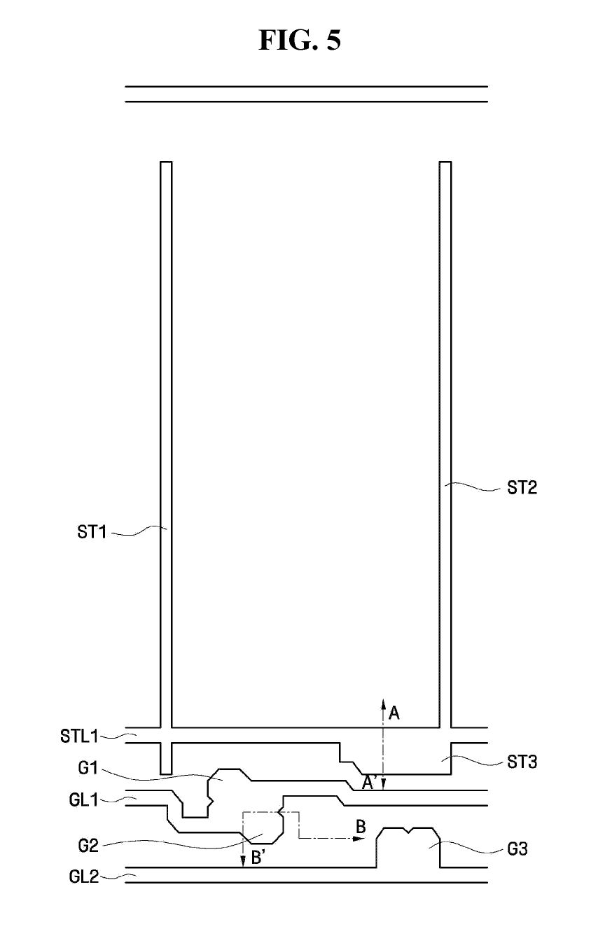

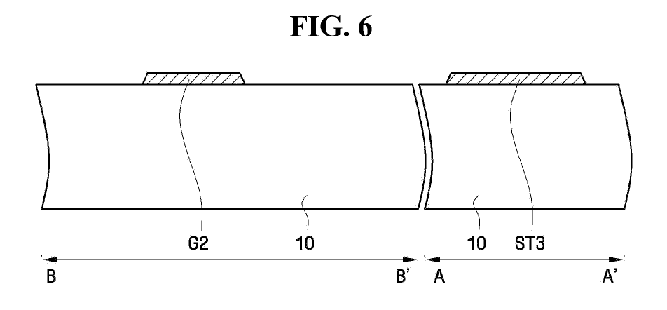

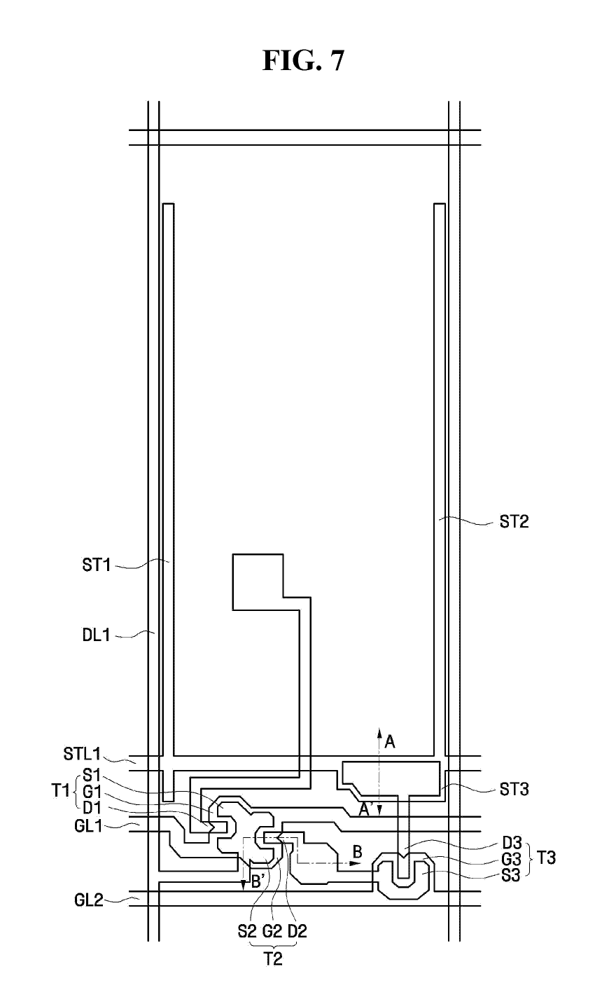

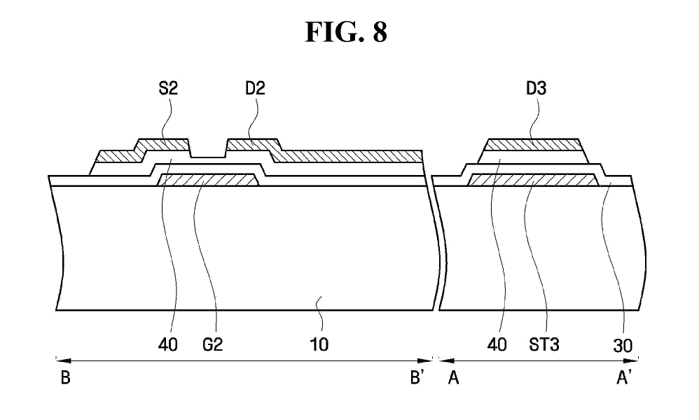

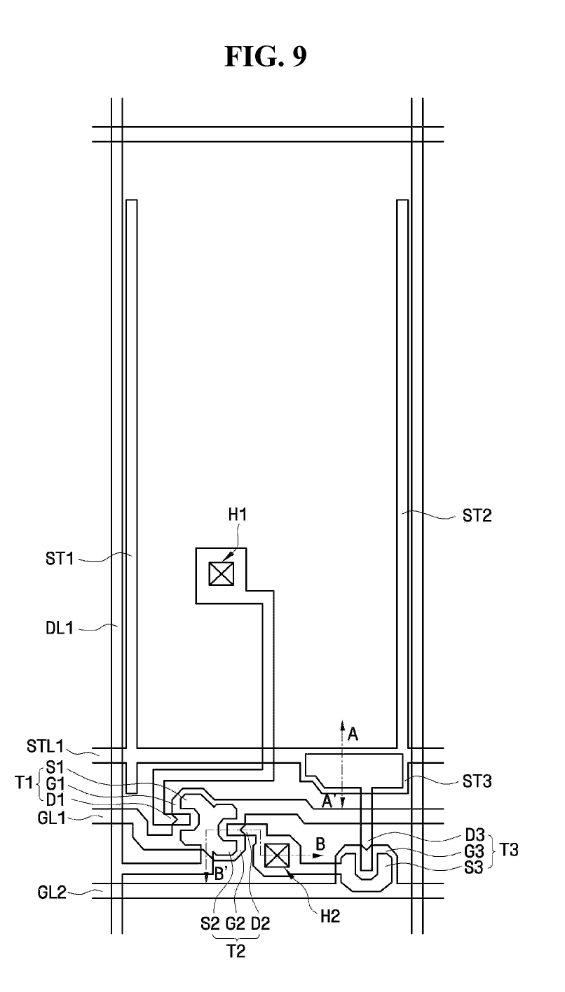

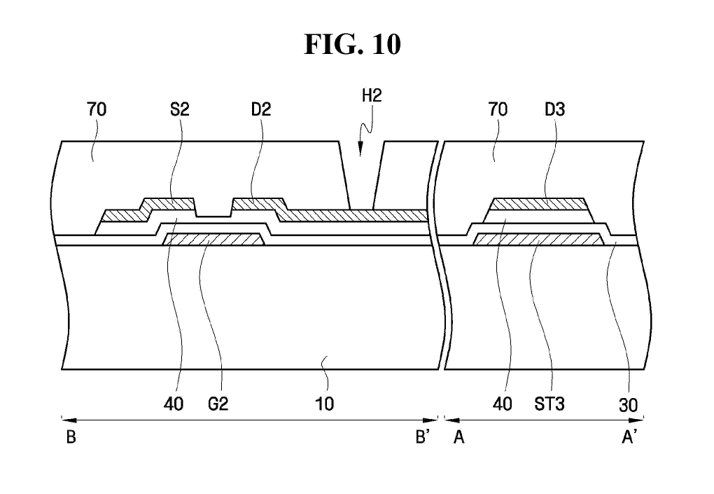

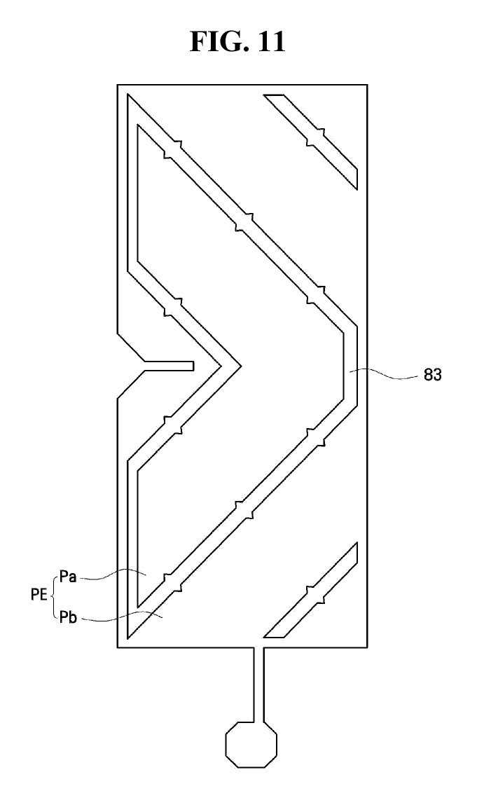

In addition, for a better understanding of the invention, intermediate processing steps of a manufacturing method of the liquid crystal display shown in FIGS. 3 and 4 are illustrated in FIGS. 5 through 10, and a plan view of an exemplary embodiment of a pixel electrode only is illustrated in FIG. 11. Specifically, FIGS. 5 and 6 are a plan view and a cross-sectional view, respectively, after forming a gate wire and a storage wire, FIGS. 7 and 8 are a plan view and a cross-sectional view, respectively after forming data lines, and FIGS. 9 and 10 are a plan view and a cross-sectional view, respectively, after forming contacts.

Referring to FIGS. 5 and 6 together with FIGS. 3 and 4, first and second gate lines GL1 and GL2 extending in a first direction, for example, in a transverse direction, are disposed on an insulating substrate 10. A first gate electrode G1 and a second gate electrode G2 are both protruded directly from the first gate line GL1, such that the first gate line GL1 is a single unitary indivisible element including the first and second gate electrodes G1 and G2. A third gate electrode G3 is protruded from the second gate line GL2, such that the second gate line GL2 is a single unitary indivisible element including the third gate electrode G3. The first and second gate lines GL1 and GL2, and the first to third gate electrodes G1, G2, and G3 are collectively referred to as gate wire.

Like the first and second gate lines GL1 and GL2, a storage line STL1 extending in the transverse direction is also disposed on the insulating substrate 10. First and second storage electrodes ST1 and ST2 extend directly from the storage line STL1, protrude in a direction toward a pixel electrode, and have at least a portion overlapping a first sub-pixel electrode Pa or a second sub-pixel electrode Pb. A third storage electrode ST3 extends directly from the storage line STL1, protrudes in an opposite direction to the direction toward the pixel electrode. The storage line STL1 is a single unitary indivisible element including the first to third storage electrodes ST1 to ST3. The direction towards and away from the pixel electrode is a second direction, crossing the first direction. However, shapes and arrangement of the storage line STL1 may be modified in various manners. The storage line STL1 and the storage electrodes ST1, ST2, and ST3 are collectively referred to as storage wire. The storage wire (STL1, ST1, ST2, and ST3) is in same layer as the gate wire (GL1, GL2, G1, G2, and G3).

The gate wire (GL1, GL2, G1, G2, and G3) and the storage wire (STL1, ST1, ST2, and ST3) preferably include one of an aluminum-based metal such as aluminum (Al) and an aluminum alloy, a silver-based metal such as silver (Ag) and a silver alloy, a copper-based metal such as copper (Cu) and a copper alloy, a molybdenum-based metal such as molybdenum (Mo) and a molybdenum alloy, chromium (Cr), titanium (Ti), tantalum (Ta) and a combination thereof. Additionally, the gate wire (GL1, GL2, G1, G2, and G3) and the storage wire (STL1, ST1, ST2, and ST3) may have a multi-layered structure in a third direction orthogonal to both the first and second directions, including two conductive layers (not shown) having different physical properties. However, the invention is not limited hereto, and the gate wire (GL1, GL2, G1, G2, and G3) and the storage wire (STL1, ST1, ST2, and ST3) may include various metals and conductive materials other than those listed herein.

Referring to FIGS. 7 and 8 together with FIGS. 3 and 4, a gate insulating film 30 is disposed on the gate wire (GL1, GL2, G1, G2, and G3) and the storage wire (STL1, ST1, ST2, and ST3).

A semiconductor layer 40 including hydrogenated amorphous silicon or polysilicon is above the gate insulating film 30, and opposite to the insulating substrate 10 with respect to the gate insulating film 30. The semiconductor layer 40, which is provided for forming channel regions of thin film transistors T1, T2, and T3, is disposed to overlap at least the gate electrodes G1, G2, and G3. In addition, the semiconductor layer 40 is patterned together with a data wire (DL1, S1, S2, S3, D1, D2, and D3), which will be described later, and is disposed under the data wire (DL1, S1, S2, S3, D1, D2, and D3) to be shaped such that the semiconductor layer 40 extends up to upper portions of the gate electrodes G1, G2, and G3 in the plan view. In other words, the semiconductor layer 40 has substantially the same shape with the data wire (DL1, S1, S2, S3, D1, D2, and D3), except that it is disposed at the channel regions of the thin film transistors T1, T2, and T3, that is, between first to third source electrodes S1, S2, and S3 and first to third drain electrodes D1, D2, and D3. The reason of patterning the semiconductor layer 40 together with the data wire (DL1, S1, S2, S3, D1, D2, and D3) is to simplify the manufacturing process by reducing the number of masking cycles.

The data wire (DL1, S1, S2, S3, D1, D2, and D3), including the data line DL1, the first source electrode S1, the second source electrode S2, the third source electrode S3, the first drain electrode D1, the second drain electrode D2, and the third drain electrode D3, is disposed on the semiconductor layer 40. The data line DL1 extends in the second direction, for example, in a longitudinal direction, and crosses the first and second gate lines GL1 and GL2. In a non-limiting embodiment, the data line DL1, and the first and second gate lines GL1 and GL2 which the data line DL1 crosses, may define a unit pixel PX. From the data line DL1, the first source electrode S1 and the second source electrode S2 are branched directly from the data line DL1 and extend to upper or outer portions of the first and second gate electrodes G1 and G2. The data line DL1 is a single unitary indivisible element including the first and second source electrodes S1 and S2.

The first drain electrode D1 is separated from the first source electrode S1 and is disposed on the semiconductor layer 40 to face the first source electrode S1 in the plan view of the first gate electrode G1. The second drain electrode D2 is separated from the second source electrode S2 and is disposed on the semiconductor layer 40 to face the second source electrode S2 in the plan view of the second gate electrode G2.

The first drain electrode D1 and the second drain electrode D2 include bar-shaped (e.g., elongated rectilinear) patterns, and drain electrode pad portions having wide areas extending directly from the bar-shaped patterns. A first contact hole H1 and a second contact hole H2 are positioned overlapping the drain electrode pad portions, respectively, to expose portions of the drain electrode pad portions. Here, the first contact hole H1 and the second contact hole H2 are formed to overlap the first sub-pixel electrode Pa and the second sub-pixel electrode Pb, respectively.

In addition, the third source electrode S3 protrudes directly from the drain electrode pad portion (including the second contact hole H2) of the second drain electrode D2, and extends toward an upper portion of the third gate electrode G3. The second drain electrode D2, the drain electrode pad portion including the second contact hole H2 and the third source electrode S3 collectively form a single unitary indivisible element.

The third drain electrode D3 is separated from the third source electrode S3 and is disposed on the semiconductor layer 40 to face the third source electrode S3 in the plan view of the third gate electrode G3. The third drain electrode D3 extends from the upper portion of the third gate electrode G3 to an upper portion of the third storage electrode ST3 of the storage line STL1. The third drain electrode D3 includes a bar-shared pattern, and a pad portion extending directly from the bar-shared pattern, having a wide area and overlapping the third storage electrode ST3. The bar-shaped pattern and the pad portion collectively form a single unitary indivisible third drain electrode D3.

Here, the first gate electrode G1, the first source electrode S1 and the first drain electrode D1 constitutes the first thin film transistor T1, the second gate electrode G2, the second source electrode S2 and the second drain electrode D2 constitutes the second thin film transistor T2, and the third gate electrode G3, the third source electrode S3 and the third drain electrode D3 constitutes the third thin film transistor T3.

The data wire (DL1, S1, S2, S3, D1, D2, and D3) preferably includes chromium, a molybdenum-based metal, or a refractory metal such as tantalum and titanium. The data wire (DL1, S1, S2, S3, D1, D2, and D3) may have a multi-layered structure in the third direction, which is constructed with a lower layer (not shown) including the refractory metal, and an upper layer (not shown) including a low resistance material.

Referring to FIGS. 9 and 10 together with FIGS. 3 and 4, a protective film (e.g., passivation layer) 70 is formed on and directly contacting the data wire (DL1, S1, S2, S3, D1, D2, and D3), portions of the semiconductor layer 40 exposed by the data wire (DL1, S1, S2, S3, D1, D2, and D3), and the gate insulation film 30. Here, the protective film 70 includes an inorganic material such as silicon nitride and silicon oxide, an organic material having an excellent planarization property and photosensitivity, and/or a low dielectric-constant insulating material formed with plasma enhanced chemical vapor deposition (“PECVD”) such as a-Si:C:O and a-Si:O:F. In order to make use of the excellent properties of an organic film and to protect the exposed portions of the semiconductor layer 40, the protective film 70 may have a two-layered structure in the third direction including a lower inorganic film and an upper organic film.

In the protective film 70, the first and second contact holes H1 and H2 which expose the drain electrode pad portions of the first and second drain electrodes D1 and D2, respectively, are formed extending completely through a thickness of the protective film 70.

Referring to FIG. 11 together with FIGS. 3 and 4, on the protective film 70, a pixel electrode PE of a roughly rectangular shape in the plan view, is formed. The pixel electrode PE includes the first sub-pixel electrode Pa connected to the first drain electrode D1 through the first contact hole H1, and the second sub-pixel electrode Pb connected to the second drain electrode D2 through the second contact hole H2. Here, the first sub-pixel electrode Pa and the second sub-pixel electrode Pb may include a transparent conductive material such as indium tin oxide (“ITO”) and indium zinc oxide (“IZO”), or a reflective conductive material such as aluminum. In the plan view, outer edges the first sub-pixel electrode Pa are completely within outer edges of the second sub-pixel electrode Pb.

The first sub-pixel electrode Pa and the second sub-pixel electrode Pb are physically and electrically connected through the first and second contact holes H1 and H2 to the first and second drain electrodes D1 and D2, to receive data voltages from the first and second drain electrodes D1 and D2, respectively. In the illustrated embodiment, since the first source electrode S1 and the second source electrode S2 transmitting the data voltages to the first drain electrode D1 and the second drain electrode D2 are connected to first drain electrode D1 and the second drain electrode D2, substantially the same data voltage supplied from the data line DL1 is applied the first sub-pixel electrode Pa and the second sub-pixel electrode Pb.

The first sub-pixel electrode Pa and the second sub-pixel electrode Pb supplied with the data voltage generate an electric field together with the common electrode of the upper panel, thereby determining the alignment of liquid crystal molecules in the liquid crystal layer interposed between the first sub-pixel electrode Pa and the common electrode, and between the second sub-pixel electrode Pb and the common electrode.

The first sub-pixel electrode Pa and the second sub-pixel electrode Pb, which form one pixel region, are separated from each other with a predetermined gap 83 disposed therebetween. An outer boundary of the pixel region has the shape of an approximate rectangle elongated substantially in the longitudinal direction.

The first sub-pixel electrode Pa has a shape of an approximately rotated “V” character, and is positioned substantially in the center of the pixel region. The second sub-pixel electrode Pb is at a portion of the rectangular pixel region, excluding the second sub-pixel electrode Pb. Here, the gap 83 includes portions forming angles of about 45 degree and −45 degree with respect to a transmission axis of a polarization plate, or the first and second gate lines GL1 and GL2. Therefore, edges of the first sub-pixel electrode Pa and the second sub-pixel electrode Pb in the vicinity of the gap 83 are substantially −45 or 45 degree (to be referred to an oblique direction, hereinafter) with respect to the transmission axis of a polarization plate or the gate lines GL1 and GL2.

The first sub-pixel electrode Pa and the second sub-pixel electrode Pb may have first domain divider means (not shown), such as a plurality of cutouts or protrusions, in the oblique direction. A display region of the pixel electrode PE is divided into a plurality of domains according to the direction in which major axes of liquid crystal molecules in the liquid crystal layer are arranged in the presence of electric field applied. The gap 83 and the first domain divider means function to divide the pixel electrode PE into as many domains as possible. Here, the domains denote regions of liquid crystal molecules having a tendency to change the direction of the major axis in a particular direction in response to the electric field generated between the pixel electrode PE and the common electrode (not shown).

As described above, when an ON signal is transmitted to the first gate line GL1, the same data voltage supplied from the data line DL1 is applied to the first and second sub-pixel electrodes Pa and Pb in the vicinity of the first gate line GL1. Next, when an ON signal is transmitted to the second gate line GL2, the data voltage stored in the second sub-pixel electrode Pb is shared with the third drain electrode D3 through the third thin film transistor T3. A charge sharing capacitor is formed between the third drain electrode D3 and the third storage electrode ST3 positioned thereunder. Therefore, the data voltage of the second sub-pixel electrode Pb is relatively low and the data voltage of the first sub-pixel electrode Pa is relatively high.

With the aforementioned liquid crystal display, one pixel electrode is divided into a pair of sub-pixel electrodes, and a difference in the data voltage applied to the respective sub-pixel electrodes is generated by charge sharing, thereby improving lateral visibility.

In the liquid crystal display constructed to improve lateral visibility, however, there may be a problem, for example, a residual image viewed on the liquid crystal display according to the data voltage applied, and one way of solving the problem will now be described.

Referring back to FIGS. 2 through 4, the first liquid crystal capacitor Clc1 includes the first sub-pixel electrode Pa connected to the first thin film transistor T1, the common electrode (not shown) of the upper panel, and the liquid crystal material (not shown) interposed therebetween. Accordingly, a voltage corresponding to a difference between the data voltage applied to the first sub-pixel electrode Pa and a voltage applied to the common electrode, which is referred to as a common voltage Vcom, hereinafter, is charged to the first liquid crystal capacitor Clc1. Here, the data voltage applied to the first sub-pixel electrode Pa is applied from the data line DL1 through the first thin film transistor T1.

Similarly, the second liquid crystal capacitor Clc2 includes the second sub-pixel electrode Pb connected to the second thin film transistor T2, the common electrode, and the liquid crystal material interposed therebetween. Accordingly, a voltage corresponding to a difference between the data voltage applied to the second sub-pixel electrode Pb and the common voltage Vcom is charged to the second liquid crystal capacitor Clc2. Here, the data voltage applied to the second sub-pixel electrode Pb is applied from the data line DL1 through the second thin film transistor T2.

As described above, since the first thin film transistor T1 and the second thin film transistor T2 are connected to the same first gate line GL1 and data line DL1, they are simultaneously turned on as soon as the ON signal is transmitted to the first gate line GL1, so that the same data voltage is applied to the first and second sub-pixel electrodes Pa and Pb.

The charge sharing capacitor Ccs includes a third drain electrode D3 of the third thin film transistor T3, a third storage electrode ST3 positioned under the third drain electrode D3, and a dielectric material interposed between the third drain electrode D3 and the third storage electrode ST3. Accordingly, a voltage corresponding to a difference between the data voltage applied to the third drain electrode D3 and a voltage applied to the third storage electrode ST3 is charged to the charge sharing capacitor Ccs. Here, the voltage applied to the third drain electrode D3 is a voltage pre-stored in the second sub-pixel electrode Pb, that is, the data voltage, which is applied to the third drain electrode D3 in a case where the ON signal is transmitted to the second gate line GL2 to turn on the third thin film transistor T3. In addition, the voltage applied to the third storage electrode ST3 is a predetermined voltage (to be referred to as a storage voltage Vcst, hereinafter) applied to the storage wire (STL1, ST1, ST2, and ST3).

The common voltage Vcom and the storage voltage Vcst have predetermined fixed values. The data voltage applied to the data line DL1 swings between a voltage having a positive value (to be referred to as a positive voltage) and a voltage having a negative value (to be referred to as a negative voltage), with respect to the common voltage Vcom. In one exemplary embodiment, for example, when the common voltage Vcom is approximately 6 volts (V), the data voltage swings between a negative voltage of 0V and a positive voltage of 12V.

Although the storage voltage Vcst having substantially the same value with the common voltage Vcom has conventionally been used, the storage voltage Vcst whose value is different from that of the common voltage Vcom is used in the invention, thereby reducing the residual image level of the liquid crystal display, which will now be described in greater detail.

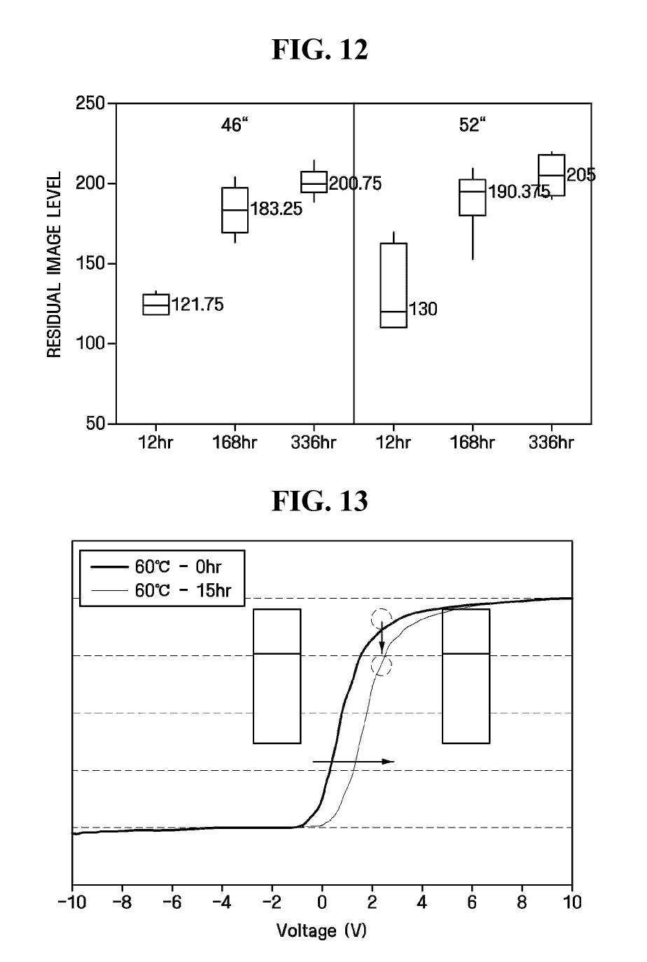

Problems generated in a case where the common voltage Vcom and the storage voltage Vcst, which have the same value, are used with the liquid crystal displays shown in FIGS. 2 through 4 are illustrated in FIGS. 12 and 13.

FIGS. 12 and 13 illustrate problems presented in a case where a common voltage Vcom and a storage voltage Vcst are same. Specifically, FIGS. 12 and 13 illustrate the time-dependent residual image levels of the liquid crystal displays and capacitance-voltage (“C-V”) characteristics of the charge sharing capacitor Ccs, assuming that a common voltage Vcom of 6V is applied to the common electrode of the upper panel, a storage voltage Vcst of 6V is applied to the storage wire (STL1, ST1, ST2, and ST3), and a data voltage swinging between 0V and 12V is applied to the data line DL1.

Referring to FIG. 12, when the common voltage Vcom of 6V, the storage voltage Vcst of 6V and the data voltage swinging between 0V and 12V are applied, the residual image levels of the liquid crystal displays considerably increased with the lapse of time. In one of the illustrated embodiments, for example, a 52 inch (″) liquid crystal display showed a residual image level of 150 G (gray) or greater at time 168 hour (hr), which is an uncommercializable level.

One of factors causing the residual image is presumably a change in the capacitance of the charge sharing capacitor Ccs.

Referring to FIG. 13, when the common voltage Vcom of 6V, the storage voltage Vcst of 6V and the data voltage swinging between 0V and 12V are applied, the C-V curve of the charge sharing capacitor Ccs showed the rightward shift over time. The rightward shift of the C-V curve suggests that there is a decrease in the capacitance of the charge sharing capacitor Ccs (see the arrow of FIG. 13).

The factor causing the change in the capacitance of the charge sharing capacitor Ccs, as shown in FIG. 13, will now be described.

As described above, the charge sharing capacitor Ccs includes the third drain electrode D3 of the third thin film transistor T3, the third storage electrode ST3 positioned under the third drain electrode D3, and the dielectric material interposed therebetween. Here, the dielectric material interposed between the third drain electrode D3 and the third storage electrode ST3 includes the gate insulation film 30 and the semiconductor layer 40 (see the cross-section taken along the line A-A′ of FIG. 4). The semiconductor layer 40 is included in the charge sharing capacitor Ccs for the purpose of simplifying the manufacturing process, because the semiconductor layer 40 is patterned together with the data wire (DL1, S1, S2, S3, D1, D2, and D3). That is to say, the charge sharing capacitor Ccs includes a kind of a metal-insulator-semiconductor (“MIS”) capacitor. When there is a change in the voltage applied, the MIS capacitor has a tendency that its capacitance changes with the lapse of time due to stress applied to a semiconductor layer.

As described above, since the data voltage swinging between a positive voltage and a negative voltage with respect to a common voltage Vcom is applied to the third drain electrode D3 of the charge sharing capacitor Ccs, the C-V characteristics and capacitance of the charge sharing capacitor Ccs may change.

As described above, if the C-V curve of the charge sharing capacitor Ccs shifts and the capacitance thereof is reduced accordingly, an amount of charge distributed from the second sub-pixel electrode Pb to the charge sharing capacitor Ccs is reduced. Thus, desired target of visibility cannot be achieved and a deviation in the brightness increases, thereby undesirably increasing the residual image level.

Therefore, in order to minimize a change in the capacitance of the charge sharing capacitor Ccs in spite of the swinging data voltage, unlike in the conventional case, the storage voltage Vcst different from the common voltage Vcom is used in the illustrated embodiment.

More specifically, a voltage that is a predetermined extent smaller than an average value of the negative voltage and the positive voltage of the data voltage with respect to the common voltage Vcom is used as the storage voltage Vcst. In one exemplary embodiment, the predetermined extent may be about 2V. In addition, the storage voltage Vcst may have a value greater than or equal to a ground voltage.

In one exemplary embodiment, for example, assuming that the common voltage Vcom is about 6V, the positive voltage of the data voltage with respect to the common voltage Vcom is about 12V, and the negative voltage of the data voltage with respect to the common voltage Vcom is 0V, the average value of the positive voltage and the negative voltage is about 6V. The storage voltage Vcst has a value that is a predetermined extent smaller than an average value of the negative voltage and the positive voltage, that is, about 6V. When the predetermined extent is about 2V, the storage voltage Vcst may be about 4V or less. In such a case, the storage voltage Vcst may also have a value greater than or equal to a ground voltage. That is to say, the storage voltage Vcst may have voltage between a ground voltage or greater and about 4V or less.

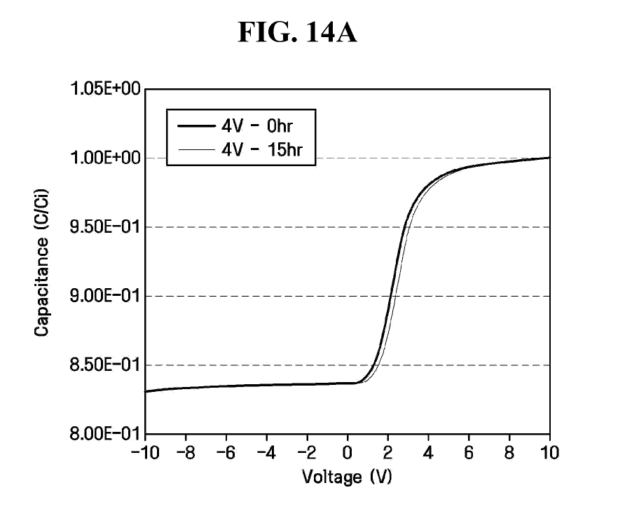

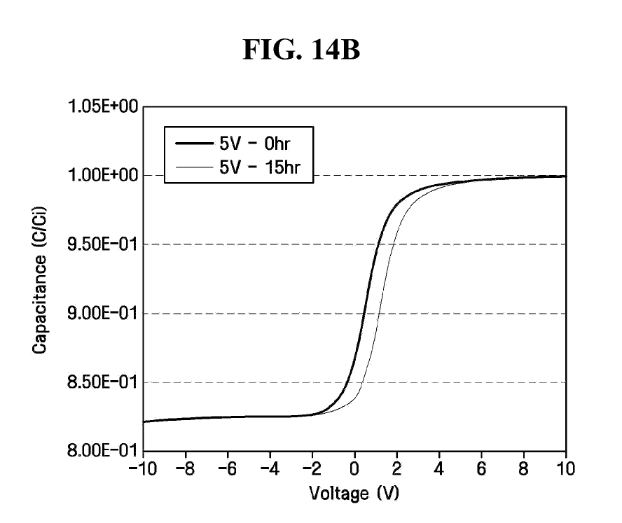

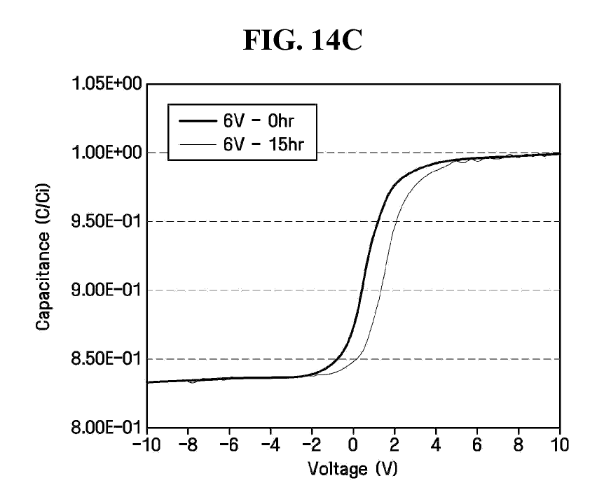

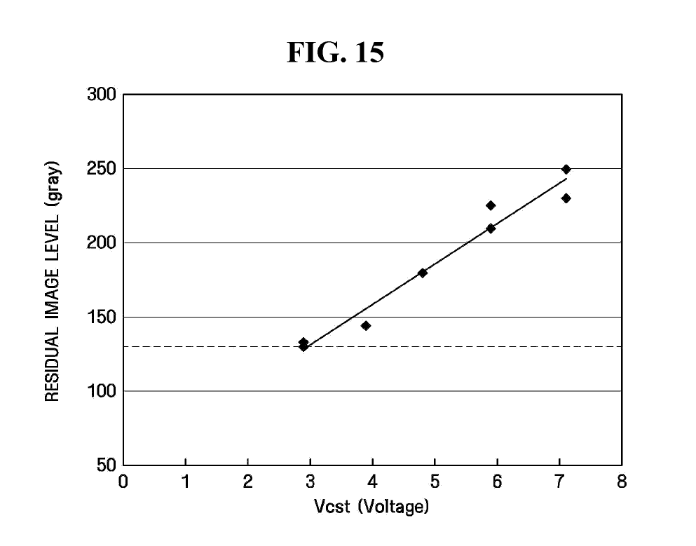

A change in the C-V characteristic of the charge sharing capacitor Ccs can be reduced by reducing the storage voltage Vcst in the above-described manner, and a change in the capacitance of the charge sharing capacitor Ccs can also be reduced, thereby reducing the residual image level of the liquid crystal display, as to be confirmed in FIGS. 14 and 15 that follow.

FIGS. 14 and 15 illustrate experimental examples in cases where a common voltage Vcom of 6V is applied to a common electrode of an upper panel, and a data voltage swinging between 0V and 12V is applied to a data line DL1.

FIGS. 14A through 14C illustrate C-V characteristics of a charge sharing capacitor depending on the storage voltage.

Referring first to FIG. 14C, like in the conventional case, when a storage voltage Vcst of 6V, which is the same as the common voltage Vcom, was applied, the rightward shift of the C-V curve was observed.

Referring to FIG. 14B, when the storage voltage Vcst was lowered to 5V, the rightward shift of the C-V curve was not so considerably big.

Referring to FIG. 14A, when the storage voltage Vcst was lowered to 4V, little shift of the C-V curve was observed over time, suggesting that there was little reduction in the capacitance of the charge sharing capacitor Ccs.

FIG. 15 illustrates residual image levels of a liquid crystal display depending on the storage voltage.

Referring to FIG. 15, as the storage voltage Vcst is reduced, the residual image level of the liquid crystal display is also reduced. In one exemplary embodiment, for example, if the storage voltage Vcst is lowered to 4V or less, the residual image level of the liquid crystal display is lowered to 150 G or less.

While the invention has been particularly shown and described with reference to exemplary embodiments thereof, it will be understood by those of ordinary skill in the art that various changes in form and details may be made therein without departing from the spirit and scope of the invention as defined by the following claims. It is therefore desired that the embodiments be considered in all respects as illustrative and not restrictive, reference being made to the appended claims rather than the foregoing description to indicate the scope of the invention.

What is claimed is:

1. A liquid crystal display comprising:
first and second gate lines arranged parallel to each other and extended in a first direction;
a data line crossing the first and second gate lines, insulated from the first and second gate lines and to which a data voltage is applied;
a pixel electrode in a pixel region, including a first sub-pixel electrode and a second sub-pixel electrode electrically disconnected from each other, and to which the data voltage is applied;
a first thin film transistor connected to the first gate line, the data line, and the first sub-pixel electrode;
a second thin film transistor connected to the first gate line, the data line, and the second sub-pixel electrode; and
a third thin film transistor connected to the second gate line, the second sub-pixel electrode, and a charge sharing capacitor,
wherein
the data voltage swings between a negative voltage and a positive voltage with respect to a common voltage, and
the charge sharing capacitor includes a first electrode to which the data voltage is applied, and a second electrode to which a voltage which is a predetermined extent smaller than an average value of the negative voltage and the positive voltage is applied.

2. The liquid crystal display of claim 1, wherein the voltage applied to the second electrode of the charge sharing capacitor has a value greater than or equal to a ground voltage.

3. The liquid crystal display of claim 1, wherein the predetermined extent is about 2 volts.

4. The liquid crystal display of claim 1, wherein the voltage applied to the second electrode of the charge sharing capacitor is about 4 volts or less.

5. The liquid crystal display of claim 4, wherein the voltage applied to the second electrode of the charge sharing capacitor has a value greater than or equal to a ground voltage.

6. The liquid crystal display of claim 4, wherein the common voltage is about 6 volts, the positive voltage is about 12 volts, and the negative voltage is 0 volts.

7. The liquid crystal display of claim 1,
further comprising a storage wire disposed on a same layer with the first and second gate lines,
wherein
the first electrode of the charge sharing capacitor is a drain electrode of the third thin film transistor, and the second electrode of the charge sharing capacitor is the storage wire, and
a semiconductor layer is interposed between the first electrode and the second electrode of the charge sharing capacitor.

8. A liquid crystal display comprising:
first and second gate lines arranged parallel to each other and extended in a first direction;
a storage wire on a same layer with the first and second gate lines;
a data line crossing the first and second gate lines, insulated from the first and second gate lines and to which a data voltage is applied;
a pixel electrode in a pixel region, including a first sub-pixel electrode and a second sub-pixel electrode electrically disconnected from each other, and to which the data voltage is applied;
a first thin film transistor connected to the first gate line, the data line, and the first sub-pixel electrode;
a second thin film transistor connected to the first gate line, the data line, and the second sub-pixel electrode; and
a third thin film transistor connected to the second gate line, the second sub-pixel electrode, and a charge sharing capacitor,
wherein the charge sharing capacitor includes:
a first electrode which is a drain electrode of the third thin film transistor,
a second electrode which is the storage wire, and
a semiconductor layer interposed between the first electrode and the second electrode.

9. The liquid crystal display of claim 8, wherein
the data voltage swings between a negative voltage and a positive voltage with respect to a common voltage,
the data voltage is applied to the first electrode of the charge sharing capacitor, and
a voltage which is a predetermined extent smaller than an average value of the negative voltage and the positive voltage is applied to the second electrode.

10. The liquid crystal display of claim 9, wherein the voltage applied to the second electrode of the charge sharing capacitor has a value greater than or equal to a ground voltage.

11. The liquid crystal display of claim 9, wherein the predetermined extent is about 2 volts.

12. The liquid crystal display of claim 9, wherein the voltage applied to the second electrode of the charge sharing capacitor is about 4 volts or less.

13. The liquid crystal display of claim 12, wherein the voltage applied to the second electrode of the charge sharing capacitor has a value greater than or equal to a ground voltage.

14. The liquid crystal display of claim 12, wherein the common voltage is about 6 volts, the positive voltage is about 12 volts, and the negative voltage is 0 volts.
